(19) United States
(12) Patent Application Publication
(10) Pub. No.: US 2019/0131889 A1
(43) Pub. Date: May 2, 2019

(54) TRIBOELECTRIC TURBINE FOR GENERATING ELECTRICITY FROM THE MOTION OF FLUIDS

(71) Applicant: UNIVERSIDADE DO PORTO, Porto (PT)

(72) Inventors: João OLIVEIRA VENTURA, Porto (PT); André Miguel TRINDADE PEREIRA, Porto (PT); Cátia Raquel DA SILVA RODRIGUES, Porto (PT); Carla Alexandra DA SILVA ALVES, Porto (PT); Filipe FALCÃO DE OLIVEIRA, Porto (PT); Joel BENTO PUGA, Porto (PT); Francisco SALGUEIRO CARPINTEIRO, Porto (PT)

(21) Appl. No.: 16/085,332

(22) PCT Filed: Mar. 14, 2017
(86) PCT No.: PCT/IB2017/051473

§ 371 Date: Sep. 14, 2018

(30) Foreign Application Priority Data
Mar. 14, 2016 (PT) 109235

(51) Int. Cl. H02N 1/04; F03B 3/04

(52) U.S. Cl. CPC H02N 1/04; F03B 3/04

(57) ABSTRACT

The present disclosure relates to a rotary triboelectric generator, device comprising different triboelectric materials for generating electricity, said generator comprising: a rotor shaft; a first triboelectric material plate fixed on said shaft; a bracket framework for receiving at least a second triboelectric material plate; a second triboelectric material plate fixed in said framework; arranged such that the first triboelectric plate comes into successive contacting and sliding against the second triboelectric plate, when said rotor shaft rotates, wherein both the first triboelectric material plate and the second triboelectric material plate are flexible plates. In particular, the first triboelectric material plate and the second triboelectric material plate are flexible plates having a different stiffness. In particular, the plate or plates fixed on the shaft are flexible and the plate or plates fixed on the brackets are stiff or flexible but less flexible than the plate or plates fixed on the shaft.

### TECHNICAL FIELD

The present disclosure relates to a rotary triboelectric generator, in particular a triboelectric generator for generating electricity from the motion of fluids, further in particular a triboelectric generator turbine for generating electricity from the motion of fluids.

### GENERAL DESCRIPTION

It is disclosed a triboelectric nanogenerator that is driven by a turbine to generate electricity from the motion of fluids. The device comprises a propeller shaft system placed in a tube to direct the fluid flow and that forces the propeller to rotate. The propeller is fixed on the shaft where one or several plates with a triboelectric material are placed. These plates rotate and come into contact with other plates composed by a triboelectric material with different tribo-polarity placed on a framework. In this structure, the triboelectric materials are isolated and, with small changes in the structure, it is possible to place the device in any environment.

In the embodiments of the present disclosure, it is made use of two operating principles different: contact and sliding modes.

In an embodiment, a type of triboelectric material has a relatively less negative triboelectric series rating and examples of suitable materials can include: air, human skin, glass, polyamide, poly(methyl metracrylate) (PMMA), a conductor, a metal, an alloy and combinations thereof. Therefore, the other type of triboelectric material is more negative and examples of such materials can include: poly(ethylene terephthalate) (PET), epoxy resin, poly-oxydiphenylene-pyromellitimide (such as Kapton), poly(vinyl chloride) (PVC), polydimethysiloxane (PDMS), polytetrafluoroethylene (PTFE), a conductor, a metal, an alloy and combinations thereof.

A preferred embodiment of the configuration of the propeller is shown in FIG. 1, where it is observed that the propeller rotated as desired for different flow rates. This propeller has a helical shape and, when attached to a support with a rotary plate which comes into contact with the plates of the framework, the propeller continues to rotate. It was found that a helical propeller is particularly suited for being placed in a tube to direct fluid flow and force the triboelectric plates to generate electricity.

With a simple design, this device has the potential to be miniaturized to the micro scale. The ability to harvest energy from a wide range of sources and under various conditions, allows this device to be used in a wide range of areas.

For different triboelectric configurations, the plates fixed in the brackets can be connected in series or parallel. For higher voltage values, the plates placed in the brackets may be connected in series. However, if the purpose is to obtain higher currents, these plates should be placed in parallel.

### BRIEF DESCRIPTION OF THE DRAWINGS

The following figures provide preferred embodiments for illustrating the description and should not be seen as limiting the scope of invention.

FIG. 1: Schematic 3D representation of an embodiment of the triboelectric driven turbine structure.

FIG. 2: Schematic representation of an embodiment of the plurality of schematic views showing the working mechanism of the triboelectric driven turbine.

FIG. 3: Summary of the influence of the water flow on (a) mean VOC (<VOC>), (b) mean current (<ISC>) and (c) maximum power density, using three different configurations of triboelectric device.

### DETAILED DESCRIPTION

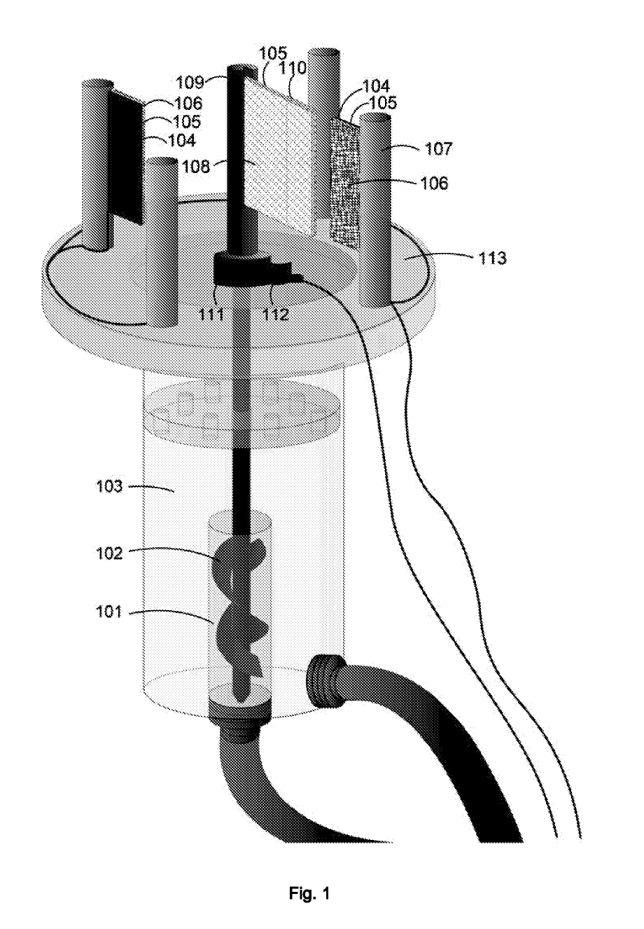

With reference to the drawings and more specifically FIG. 1, the triboelectric driven turbine is schematically represented. The triboelectric driven turbine (FIG. 1) is comprised by a propeller 102 placed into a tube 101 (for example, with 2.5 cm of diameter and 9 cm of height) to direct the fluid flow and consequently the propeller 102 is forced to rotate. This set is placed into a tube 103, for example an acrylic tube with a diameter of 6 cm and a height of 13 cm, where the propeller 102 rotates for different fluid flows.

The propeller 102 has a helical shape and is attached to a support with a shaft 109.

The triboelectric material 110 is fixed on the shaft 109 (for example, with 1.8 cm of diameter and 8.3 cm of height) that rotates using the motion of the propeller 102 caused by the fluid flow. The electrical contact to this plate is optimized by the use of a sliding contact, for example a brass plate 111, in the shaft 109, which promotes the conduction of charges from the sliding contact/plate with the triboelectric material 110 to the external circuit.

A copper brush 112 makes the electrical contact with the shaft 109. Consequently, the plate with the triboelectric material 110 fixed on shaft 109 comes into contact with the plates with the triboelectric material 106 fixed on the framework 113.

The framework 113 (for example, with a diameter of 13 cm and a height of 9 cm) has four (for example) brackets to place the triboelectric material 106, which allows to use only one, two or four brackets 107. The framework may comprise a different number of brackets, for example, 2, 3, 4, 5, 6 or more brackets.

When the triboelectric configuration is constituted by more than one bracket 107, having more than one plate, the plates fixed in the brackets 107 can be connected in series or parallel.

The plates fixed on the brackets 107 and shaft 109 have two types of triboelectric materials and have different characteristics in relation to its stiffness. The plates fixed on the shaft are flexible and the plates fixed on the brackets are stiff, or flexible but less flexible than the shaft plates, which improves the triboelectric contact area between them when they come in contact.

After the plates come into contact, their different stiffness allows to improve the dynamic contact between them, by a continuous sliding aligned with the movement, i.e. when the flexible plate is at the final sliding phase, the contact area is larger than if both plates had the same stiffness, because the softer plate adapts more readily to the other plate.

The plates which are fixed in the brackets 107 are constituted by two sheets (2 cm×5 cm) of Kapton 104, a layer of aluminium sheet 105 (2 cm×5 cm) as electrode and a Nylon 6.6 film 106 (1.5 cm×5 cm) that is the triboelectric material. The plate fixed on the shaft 109 is constituted by a sheet of ITO/PET 108 (4 cm×5 cm), a layer of aluminium sheet 105 (4 cm×5 cm) as electrode and a Polytetrafluoroethylene (PTFE) film 110 (1.5 cm×5 cm) as the other triboelectric material.

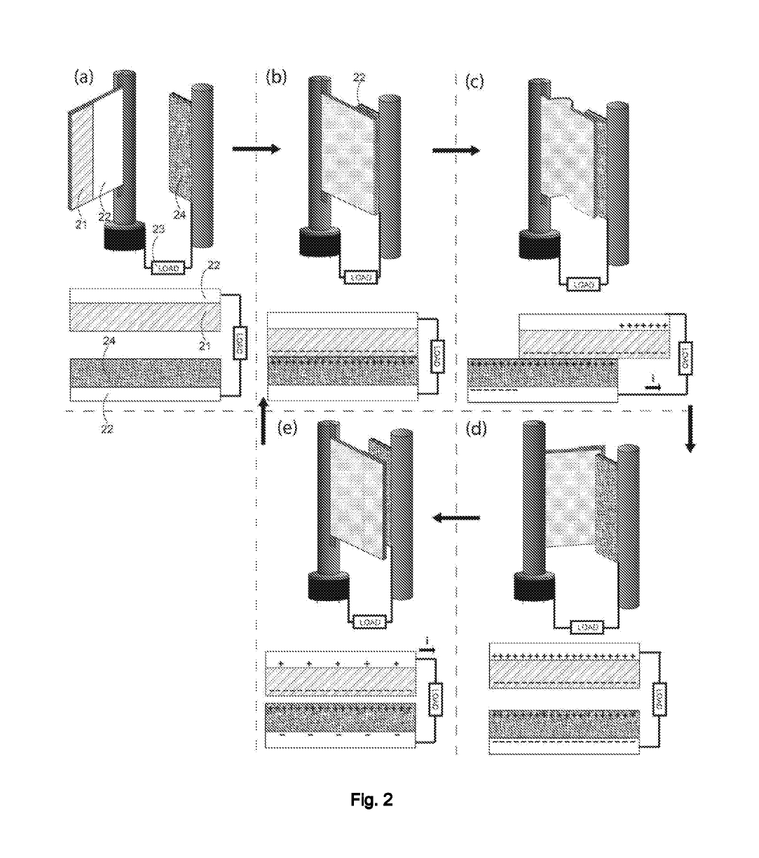

The operating principle of the triboelectric driven turbine can be described by the coupling of contact charging and electrostatic induction as shown in FIG. 2 in an embodiment in which the triboelectric materials comprise Nylon 6.6 24 and PTFE 21 films. When there is no fluid flow, the propeller 102 is stationary and consequently, the triboelectric layers (Nylon 6.6 24 and PTFE 21) are separated from each other. This corresponds to the initial state [FIG. 2(a)], where there are no tribo-charges on the triboelectric surface. Immediately upon beginning the fluid flow, the propeller 102 and the plate fixed on the shaft 109 start to rotate, bringing the PTFE film 21 into full contact with the Nylon 6.6 24 on either one of the brackets 107 [FIG. 2 (b)].

The triboelectric materials in contact have different tribo-polarities (i.e. different tendencies to gain or lose electrons) and the triboelectric effect will enable the generation of surface charges at the contact area (leaving the PTFE 21 with net negative charge and the Nylon 6.6 24 with positive charge). The contact surfaces have opposite charges with equal densities and a small electric potential difference is generated [FIG. 2(b)].

The propeller continues to rotate and, since the PTFE plate is flexible, it will bend in order to sweep across the more rigid Nylon plate [FIG. 1(c)]. The strong electrostatic attraction between the two tribo-charged surfaces has the tendency to keep the intimate contact between the PTFE film 21 and the Nylon 6.6 film 24. With the rotation of the propeller 102, the PTFE plate is guided to slide across the Nylon surface and there is a continuous decrease in the overlapping area between the two triboelectric surfaces.

During sliding, due to the incomplete overlap of the surfaces, a disequilibrium of charges appears and these charges generate an electric field almost parallel to the plates, inducing a higher potential at the electrode 22 of the Nylon layer 24. The generated potential difference drives a current flow in the external load 23 from the electrode 22 of the Nylon layer to that of the PTFE layer in order to generate an electric potential drop that cancels the tribo-charge-induced potential. This process continues until the two triboelectric layers are entirely separated [FIG. 1(d)] and the total transferred charges be equal the amount of the triboelectric charges on each surface.

With the fluid flow, the propeller 102 continues to rotate until it arrives to the next bracket with another Nylon plate [FIG. 1(e)].

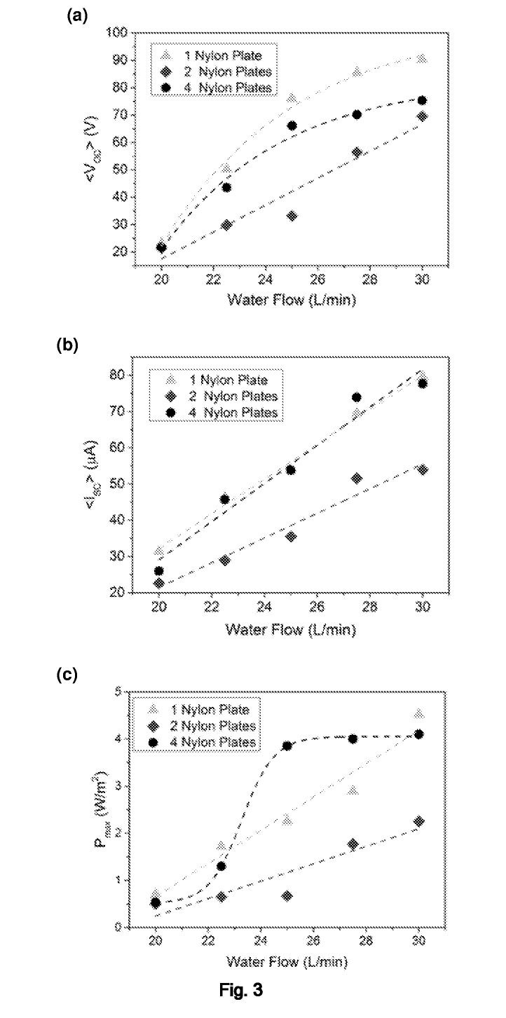

For three configurations of triboelectric device and with different water flows, it was studied which configuration was the best for the effective harvesting of energy through water movement. These studies revealed that the open-circuit voltage (VOC) increases with increasing water flow, with the maximum VOC occurring for the maximum used water flow of 30 L/min. The largest electrical output takes place for 30 L/min and the structure constituted by four brackets (four Nylon plates and one PTFE plate) leads to a better device performance, with a power per second of 153.7 mW/s and power per cycle of 11.0 mW/cycle. For this configuration it was obtained a mean VOC of 75.3 V [FIG. 3 (a)], a mean current of 77.7 μA [FIG. 3 (b)] and a maximum power density of 4.1 W/m2 [FIG. 3 (c)].

While specific embodiments of this invention have been shown and described, it should be understood that many variations thereof are possible. The description of the present invention has been presented for purposes of illustration and description, and is not intended to be exhaustive or limited to the invention in the form released. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

It is disclosed a rotary system comprising different triboelectric materials able to generate electricity.

It is disclosed a triboelectric driven turbine to generate electricity from the motion of fluid, comprising:

a propeller placed into a tube to direct the fluid flow and to be forced to rotate, where the propeller is attached to a support with a shaft;
plates with the first triboelectric material are fixed on the shaft that rotates using the motion of the propeller caused by the fluid flow; and
a framework with brackets where the plates with the second triboelectric materials are fixed.

In an embodiment of the triboelectric device, the device can be coupled inline to various fluid movements such on oil extraction, engine-cooling system in the car, the refrigeration system in the aircraft and/or applied to restrict areas in extreme conditions.

In an embodiment of the triboelectric device, the fan, propeller or screw propeller has helical, cycloidal shape.

In an embodiment of the triboelectric device, the input direction of fluid flow is perpendicular or parallel to the fan, propeller or screw propeller.

In an embodiment of the triboelectric device, the first and second triboelectric materials comprise materials selected from a triboelectric series and with opposite tribo-polarities.

In an embodiment of the triboelectric device, the surface morphology of triboelectric materials comprises a texture that includes a plurality of structures made by physical processes and chemical functionalization.

In an embodiment of the triboelectric device, in each of the sides of the first and second triboelectric materials is placed a conductor that acts as the respective electrode.

In an embodiment of the triboelectric device, the plates with the two types of triboelectric materials have different characteristics in relation to the stiffness.

In an embodiment of the triboelectric device, the plate (or plates) fixed on the shaft are flexible and the plate (or plates) fixed on the brackets are stiff or less flexible than the plate (or plates) fixed on the shaft.

In an embodiment of the triboelectric device, the plates fixed on the brackets are connected in series or parallel.

In an embodiment of the triboelectric device, it is operated by a method of generating an electrical current and voltage for a triboelectric device, comprising the steps of:

bringing the first triboelectric material into full contact with the second triboelectric material, when the propeller starts to rotate due to the fluid flow;
continuing the propeller to rotate, the plate with the first triboelectric material is guided to slide across the surface of the plate with the second triboelectric material; and
applying a load between the plate with the first triboelectric material and the plates with the second triboelectric material, thereby causing an electrical current to flow through the load.

In an embodiment of the triboelectric device, the device is applied as a self-powered sensor that can work, and send data using fluid movements.

In an embodiment of the triboelectric device, the device incorporates other types of energy harvesters by hybridization, like, for example, piezoelectric nanogenerators or magnetic induction.

The term “comprising” whenever used in this document is intended to indicate the presence of stated features, integers, steps, components, but not to preclude the presence or addition of one or more other features, integers, steps, components or groups thereof.

The disclosure should not be seen in any way restricted to the embodiments described and a person with ordinary skill in the art will foresee many possibilities to modifications thereof.

The following claims further set out particular embodiments of the disclosure.

1. A rotary triboelectric generator device comprising different triboelectric materials for generating electricity, said generator comprising:
a rotor shaft;
a first triboelectric material plate fixed on said shaft;
a bracket framework; and
a second triboelectric material plate fixed in said bracket framework;
wherein the bracket framework and the first triboelectric plate are configured to contact and slide successively against the second triboelectric plate when said rotor shaft rotates, and
wherein both the first triboelectric material plate and the second triboelectric material plate are flexible plates.

2. The triboelectric device according to claim 1, wherein the first triboelectric material plate and the second triboelectric material plate are flexible plates having a different stiffness.

3. The triboelectric device according to claim 1, further comprising a driven turbine configured to generate electricity from the motion of fluid, the turbine comprising:
a tube;
a propeller disposed in the tube to direct the fluid flow and thereupon to be forced to rotate, wherein the propeller is attached to said rotor shaft;
such that said rotor shaft rotates in response to motion of the propeller caused by the fluid flow.

4. The triboelectric device according to claim 3, wherein the propeller has a helical, cycloidal, fan or screw shape.

5. The triboelectric device according to claim 3, wherein the input direction of fluid flow is perpendicular or parallel to the propeller.

6. The triboelectric device according to claim 1, for coupling inline to fluid movements.

7. The triboelectric device according to claim 1, wherein the first and second triboelectric materials comprise materials selected from a triboelectric series and with opposite tribo-polarities.

8. The triboelectric device according to claim 1, wherein the surface morphology of triboelectric materials comprises a texture that includes a plurality of structures made by physical processes and chemical functionalization.

9. The triboelectric device according to claim 1, wherein further comprising a conductor placed on one side of the first and second triboelectric materials, the conductor configured to serve as an electrode.

10. The triboelectric device according to claim 1, wherein the plates with the two types of triboelectric materials have different stiffness characteristics.

11. The triboelectric device according to claim 1, wherein the plate or plates fixed on the shaft are flexible and wherein the plate or plates fixed on the brackets are stiff or less flexible than the plate or plates fixed on the shaft.

12. The triboelectric device according to claim 1, comprising a plurality of first triboelectric material plates fixed on said shaft and/or a plurality of second triboelectric material plates fixed in said framework.

13. The triboelectric device according to claim 12, wherein the plates fixed on the brackets are connected in series or parallel and/or the plates fixed in said framework are connected in series or parallel.

14. The triboelectric device according to claim 1, further comprising a self-powered sensor configured to work the sensor and send data using a fluid flow.

15. The triboelectric device according to claim 1, wherein the device incorporates other types of energy harvesters by hybridization.
